(19) United States
(12) Patent Application Publication
(10) Pub. No.: US 2008/0035441 A1
(43) Pub. Date: Feb. 14, 2008

(54) Telescopic heat isolation assembly of oil pressure rod

(76) Inventor: Tsung-Yu Chen, Taichung City (TW)

Correspondence Address: TSUNG-YU CHEN, 235 Chung-Ho, Box 8-24, Taipei, omitted

(21) Appl. No.: 11/490,275

(22) Filed: Jul. 21, 2006

(51) Int. Cl. F16F 9/24

(52) U.S. Cl. 188/297

(57) ABSTRACT

A telescopic heat isolation assembly of an oil pressure rod has an oil pressure rod body which has a spindle extended from an interior thereof. An outer sleeve encloses the oil pressure rod body. A pivotal portion is formed at one end of the oil pressure rod. By the position portion and pivotal portion, the oil pressure rod can be assembled to another object. A spindle sleeve encloses the spindle of the oil pressure rod body. An inner diameter of the spindle sleeve is slightly larger than the oil pressure rod body and the outer sleeve. One end of the spindle sleeve is formed with a head. An inner space of the head is communicated to the spindle sleeve for receiving a pivotal portion. Two sides of the head have openings so that the pivotal portion in the head can be assembled with other object through the opening.

### FIELD OF THE INVENTION

The present invention relates to oil pressure rods, and in particular to a telescopic heat isolation assembly of an oil pressure rod, wherein the oil pressure rod and spindle are enclosed by an outer sleeve and a spindle sleeve so that heat from the oil pressure rod is completely isolated and thus the user will not be hurt.

### BACKGROUND OF THE INVENTION

Small size exercise machines are more and more popular in home and are suitable for people of various ages. Thus, many manufacturers develop various kinds of small size exercise machines for matching the requirement of markets.

Oil pressure rods have the advantages of providing damping effect and storing pressure so that the oil pressure rods are widely used in exercise machines, such as to be connected to a treadle of a treading machine. However in use, each time the exercise machine is used for a longer time period and thus the friction of the oil pressure rod will become hot due to the friction. As a result, the user is frequently burned by the rod, even the user is not burned, but he (or she) is scared.

Thus, there is an improvement being provided, in that a sleeve is used to enclose the oil pressure rod. The sleeve has a plurality of holes at one end. A cover has a plurality of posts arranged corresponding to the holes of the sleeve. Furthermore, the sleeve and the cover have via hole for protruding a spindle of the oil pressure rod. Thus, the effect of heat isolation is achieved.

However above mentioned prior art structure does not enclose the spindle. As a result the spindle is possible to burn the user. Thus the prior art cannot completely resolve the problem in the prior art.

### SUMMARY OF THE INVENTION

Accordingly, the primary object of the present invention is to provide a telescopic heat isolation assembly of an oil pressure rod, wherein the oil pressure rod and spindle are enclosed by an outer sleeve and a spindle sleeve so that heat from the oil pressure rod is completely isolated and thus the user will not be hurt.

To achieve above objects, the present invention provides a telescopic heat isolation assembly of an oil pressure rod, wherein an oil pressure rod body has a spindle extended from an interior thereof and out of a first end of the oil pressure rod body. An outer sleeve sleeves the oil pressure rod body. A position portion is installed at a second end of the oil pressure rod body opposite to the first end of the oil pressure rod body. A pivotal portion is formed at one end of the oil pressure rod. By the position portion and pivotal portion, the oil pressure rod can be assembled to another object to present the effects of damping and pressure storage. A spindle sleeve encloses the spindle of the oil pressure rod body. An inner diameter of the spindle sleeve is slightly larger than the oil pressure rod body and the outer sleeve. One end of the spindle sleeve is formed with a head. An inner space of the head is communicated to the spindle sleeve for receiving a pivotal portion. Two sides of the head have openings so that the pivotal portion in the head can be assembled with other object through the opening.

The various objects and advantages of the present invention will be more readily understood from the following detailed description when read in conjunction with the appended drawing.

### BRIEF DESCRIPTION OF THE DRAWINGS

FIG. 1 is a schematic view of the telescopic heat isolation assembly of an oil pressure rod of the present invention.

FIGS. 2 and 3 are schematic view of the telescopic heat isolation assembly of an oil pressure rod of the present invention.

FIG. 4 is an assembled lateral view of the telescopic heat isolation assembly of an oil pressure rod of the present invention.

FIG. 5 is a schematic view showing at the telescopic heat isolation assembly of an oil pressure rod of the present invention being at an extension state.

FIG. 6 is a lateral view showing that the present invention is assembled to a treading machine.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

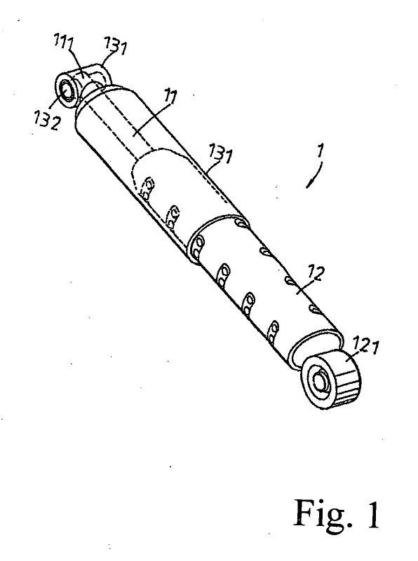

Referring to FIG. 1, the telescopic heat isolation assembly of an oil pressure rod of the present invention is illustrated. The present invention has the following elements.

An oil pressure rod body 1 has a spindle 11 extended from an interior thereof and out of a first end of the oil pressure rod body 1. The spindle 11 is connected to a plug (not shown) in the oil pressure rod 1. The telescopic movement of the spindle 11 provides the functions of damping and pressure storage.

An outer sleeve 12 sleeves the oil pressure rod body 1 for preventing the oil pressure rod body 1 to burn the user.

A position portion 121 is installed at a second end of the oil pressure rod body 1 opposite to the first end of the oil pressure rod body 1. A pivotal portion 111 is formed at one end of the oil pressure rod 1. By the position portion 121 and pivotal portion 111, the oil pressure rod can be assembled to another object to present the effects of damping and pressure storage.

The principle and structure of the oil pressure rod are known in the prior art and thus the details will not be further described herein.

A spindle sleeve 13 encloses the spindle 11 of the oil pressure rod body 1. An inner diameter of the spindle sleeve 13 is slightly larger than the oil pressure rod body 1 and the outer sleeve 12. One end of the spindle sleeve 13 is formed with a head 131. An inner space of the head 131 is communicated to the spindle sleeve 13 for receiving a pivotal portion 111. Two sides of the head 131 have openings 132 so that the pivotal portion 111 in the head 131 can be assembled with other object through the opening 132. When the spindle 11 of the oil pressure rod body 1 telescopically moves, since the head 131 is installed in the pivotal portion 111 of the spindle 11, the spindle sleeve 13 will axially move along the oil pressure rod body 1 and out of the outer sleeve 12 so as to isolate the heat of the spindle 11.

The oil pressure rod body 1 of the present invention can be assembled to a small size body exerciser or other object and by the damping and pressure storage effects of the spindle 11 can be effectively functioned. In the present invention, one example of the present invention is illustrated, wherein the oil pressure rod body 1 is assembled to a treading machine. However this is not used to confine the scope of the present invention.

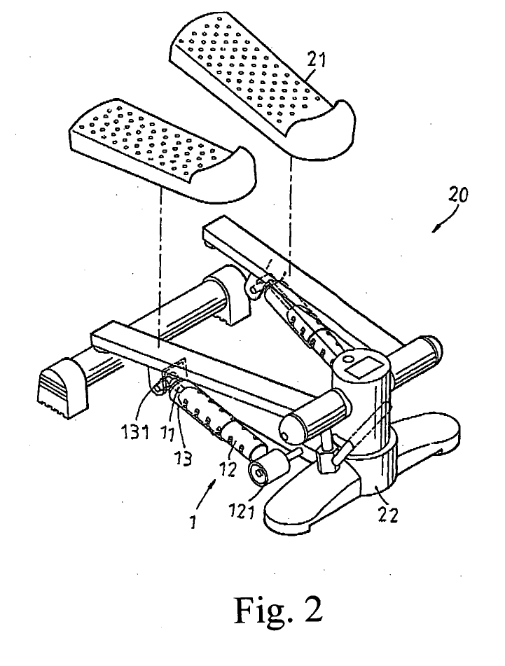

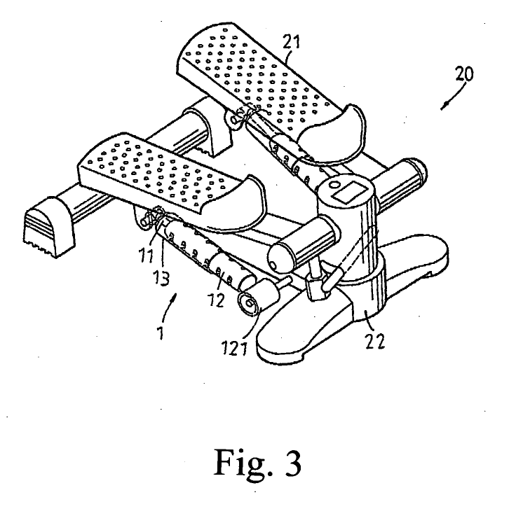

Referring to FIGS. 2 to 4, the oil pressure rod body 1 is assembled to a treadle 21 of the treading machine 20 and is interacted with the treadle 21 so as to provide a damping force to the treadle 21 to have the effect of exercise.

The position portion 121 of the outer sleeve 12 of the oil pressure rod body 1 is assembled to a seat 22 of the treading machine 20. The spindle 11, pivotal portion 111 of the spindle sleeve 13, and the head 131 are pivoted to the lower end of the treadle 21 so as to telescopically move with the treadle 21.

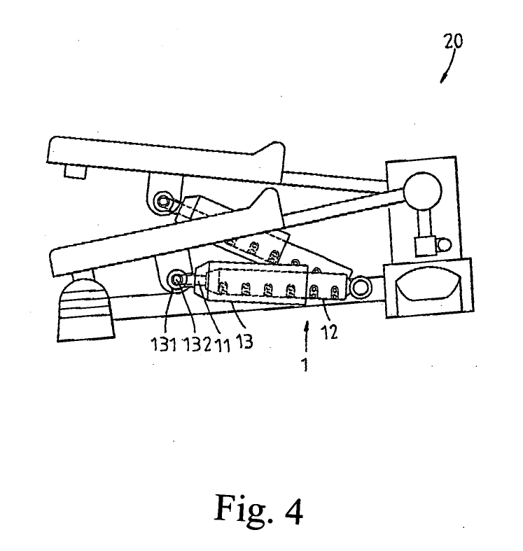

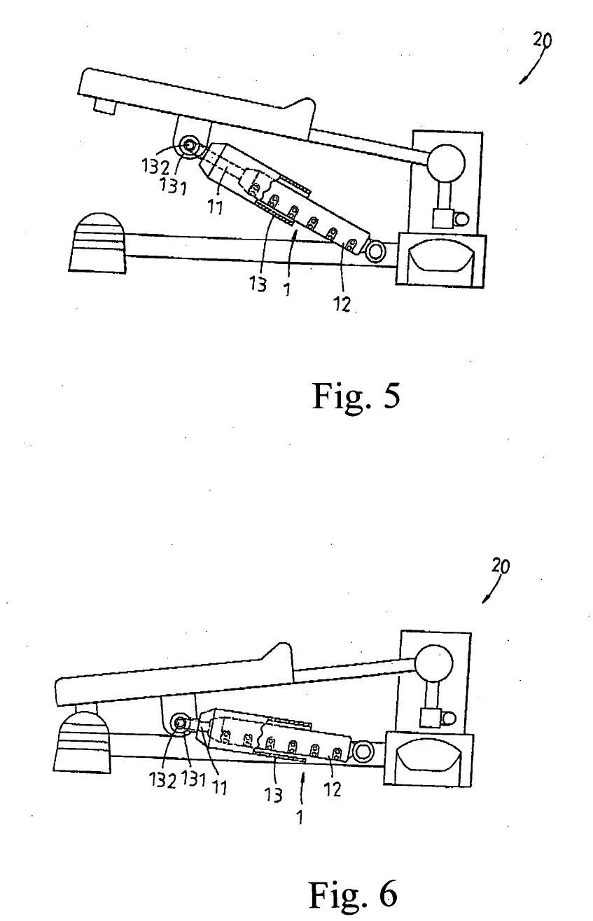

In use of the present invention, referring to FIGS. 5 and 6 (where only the treadle 21 of the treading machine 20 and the oil pressure rod body 1 at one side is illustrated for brevity).

When the treadle 21 is at a higher place and is not treaded, the spindle 11 of the oil pressure rod body 1 is at an extension state, the spindle sleeve 13 out of the spindle 11 is pulled to be out of the outer sleeve 12 and the oil pressure rod body 1, as shown in FIG. 5.

When the treadle 21 is treaded, as shown in FIG. 6, the spindle 11 of the oil pressure rod body 1 is compressed into the oil pressure rod body 1, and then the spindle sleeve 13 at the outer side of the spindle 11 is interacted with the pivotal portion 111 of the spindle 11 so as to move along the oil pressure rod body 1 to displace toward the position portion 121 of the outer sleeve 12.

When the treadle 21 returns to the higher position and is not treaded, the spindle 11 is pulled with the treadle 21 to have a longer length and the spindle sleeve 13 out of the spindle 11 will be driven by the pivotal portion 111 to return to the state separated from the oil pressure rod body 1. Thus the spindle 11 is enclosed by the spindle sleeve 13.

The spindle sleeve 13 may move out of the outer sleeve 12 with the extension of the spindle sleeve 13 so as to prevent the spindle 11 to contact and thus burn the user, but the movement of the spindle 11 is not interfered. The extension and compression of the spindle sleeve 13 are helpful to drive the internal air to flow effectively so as to increase the heat dissipation of the oil pressure rod body 1.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A telescopic heat isolation assembly of an oil pressure rod comprising:
a spindle;
a spindle sleeve installed at one end of the spindle and enclosing the spindle; an inner diameter of the spindle sleeve being greater than an outer diameter of the oil pressure rod body; the spindle sleeve being telescopically moved with the spindle so as to move along the oil pressure rod body to isolate heat of the spindle sleeve.

2. The telescopic heat isolation assembly of an oil pressure rod as claimed in claim 1, wherein an end of the spindle far away from the oil pressure rod body has a pivotal portion and one end of the spindle sleeve is installed to the pivotal portion.

3. The telescopic heat isolation assembly of an oil pressure rod as claimed in claim 1, wherein an outer side of the oil pressure rod body is enclosed by an outer sleeve and an inner diameter of the spindle sleeve is slightly larger than an outer diameter of the outer sleeve.

4. The telescopic heat isolation assembly of an oil pressure rod as claimed in claim 1, wherein one end of the spindle sleeve is formed with an head and inner space is communicated to an interior of the spindle sleeve; each of two sides of the head has an opening; and the pivotal portion of the spindle sleeve is received in the spindle so that the spindle can be assembled to other object.
